(19) United States
(12) Patent Application Publication
(10) Pub. No.: US 2007/0031176 A1
(43) Pub. Date: Feb. 8, 2007

(54) Cap for a pencil, in particular a cosmetic pencil, incorporating a pencil-sharpener, and pencil, in particular cosmetic pencil, fitted with a cap of this kind

(76) Inventor: Gerard Gieux, Paris (FR)

Correspondence Address: STEVENS, DAVIS, MILLER & MOSHER, LLP, 1615 L. STREET N.W., SUITE 850, WASHINGTON, DC, 20036, US

(21) Appl. No.: 11/269,577

(22) Filed: Nov. 9, 2005

(30) Foreign Application Priority Data
Aug. 2, 2005 (FR) 0508234

(51) Int. Cl. B43K 29/06; B43K 19/02

(52) U.S. Cl. 401/50; 401/96

(57) ABSTRACT

A cap for a pencil, in particular a cosmetic pencil, comprises a cap body provided with a pencil-sharpener and adapted to be nested over one end of the pencil, a cap top adapted to be nested fixedly onto said cap body, and means attached to said cap top for restricting movement of said pencil relative to said cap body.

### BACKGROUND OF THE INVENTION

1. Field of the invention

The present invention relates to a cap for a pencil, in particular a cosmetic pencil, incorporating a pencil-sharpener and to a pencil, in particular a cosmetic pencil, fitted with a cap of this kind.

2. Description of the Prior Art

Pencils, and in particular cosmetic pencils intended for applying make-up, must be sharpened regularly in order to obtain the required line thickness.

Using a conventional pencil-sharpener, independent of the pencil itself, has proved to be somewhat impractical: it is very easy to lose a small object such as a pencil-sharpener, and in any event difficult to find it among other objects at the bottom of a handbag, for example.

For this reason, caps for cosmetic pencils have been developed in recent years that incorporate a pencil-sharpener. Such caps have two functions, namely protecting the tip of the pencil and sharpening it. With caps of this kind, the problem of losing the pencil-sharpener is eliminated.

In a first variant, the pencil-sharpener is disposed in a portion of the cap at the opposite end from that in which the pencil is intended to be housed.

In a variant of this kind, the overall size of the cap is large, which is unsatisfactory, in particular from the esthetic point of view. Furthermore, a cap of this kind is complex to fabricate.

In a second variant, the pencil-sharpener is disposed at the far end of the portion in which the pencil is intended to be housed.

Although highly advantageous, caps conforming to this second variant have certain drawbacks.

In particular, it has been found that, because the cap comprises means rubbing on the pencil to retain the cap on the pencil when not in use, rotating the pencil inside the cap to sharpen it requires a certain force.

This force is certainly not insurmountable, but it would be preferable if there were practically no force, as this would be more agreeable for the user.

One object of the present invention is to eliminate this drawback in particular.

### SUMMARY OF THE INVENTION

This object of the invention is achieved by a cap for a pencil, in particular a cosmetic pencil, comprising:
a cap body provided with a pencil-sharpener and adapted to be nested over one end of said pencil,
a cap top adapted to be nested fixedly onto said cap body, and
means attached to said cap top for restricting movement of said pencil relative to said cap body.

Because the means for restricting movement of the pencil relative to the cap body are attached to the cap, it suffices to take off the cap to obtain total freedom of movement of the pencil relative to the cap body, and in particular, to allow effortless rotation of the former relative to the latter during sharpening.

According to an optional further feature of the invention, said restricting means comprise means for maintaining a tip, and in particular a lead, of said pencil at a predetermined distance from a blade of said pencil-sharpener.

Maintaining the tip of the pencil, and above all its lead, at a predetermined distance from the blade of the pencil-sharpener in the cap body prevents the blade of the pencil-sharpener cutting pieces off the tip of the pencil, and in particular the lead, when replacing the cap on the pencil, with the risk of compromising the esthetics of the pencil and weakening its lead.

According to further optional features of the invention:
said restricting means comprise a rib on the inside of said cap adapted to form an abutment for said pencil,
said cap body is transparent and said abutment is positioned so that said lead can be seen through said cap body, said pencil-sharpener being concealed by said cap top, which may be opaque,
said restricting means comprise at least one spring clip attached to said cap top and adapted to bear against said pencil. This elastic clip may be curved or straight, inside or outside the cap body, and more or less rigid,
said cap body has a groove on its inside face and said clip is conformed to be housed in said groove when said cap top is nested over said cap body,
said clip and said cap body comprise mutual clipping means releasable only when said clip is free to move away from said groove, i.e. when said pencil is extracted from said cap,
said cap body and said cap top are shaped so that in the nesting configuration their outside walls are substantially in line with each other,
the inside face of said cap body includes ribs to improve the retention of said cap body on said pencil.

The present invention also relates to a pencil, in particular a cosmetic pencil, fitted with a cap as defined hereinabove.

Other features and advantages of the invention will become apparent in the light of the following description and the appended drawings.

### BRIEF DESCRIPTION OF THE DRAWINGS

FIG. 1 is an exploded perspective view of the pencil cap of the invention.

FIG. 2 is a view of the cap body in section in the plane P1 in FIG. 1.

FIG. 3 is a view of the cap top of the cap in section in the plane P1 in FIG. 1.

FIGS. 4 and 5 are views of the cap body from FIG. 2 and the cap top from FIG. 3 when they are nested one inside the other in section the planes P1 and P2 in FIG. 1, respectively.

FIGS. 6 and 7, which are analogous to FIGS. 4 and 5, respectively, show how the cap of the invention cooperates with the end of a cosmetic pencil.

FIG. 8 is a view analogous to FIG. 6 of another embodiment of the invention.

FIGS. 9 and 10 are views analogous to FIGS. 4 and 6 of a further embodiment of the invention, with an economical straight clip.

FIG. 11 is a view in section taken along the line 11-11 in FIG. 9.

FIGS. 12 and 13 are views analogous to FIGS. 4 and 6 of a variant of the embodiment of FIGS. 9 and 10.

FIGS. 14 and 15 are views in section taken along the lines 14-14 and 15-15 in FIGS. 12 and 13, respectively.

FIGS. 16 and 17 are views analogous to FIGS. 4 and 6 of a further embodiment of the invention.

FIGS. 18 and 19 are views in section taken along the lines 18-18 and 19-19 in FIGS. 16 and 17, respectively.

### DETAILED DESCRIPTION OF THE PREFERRED EMBODIMENTS

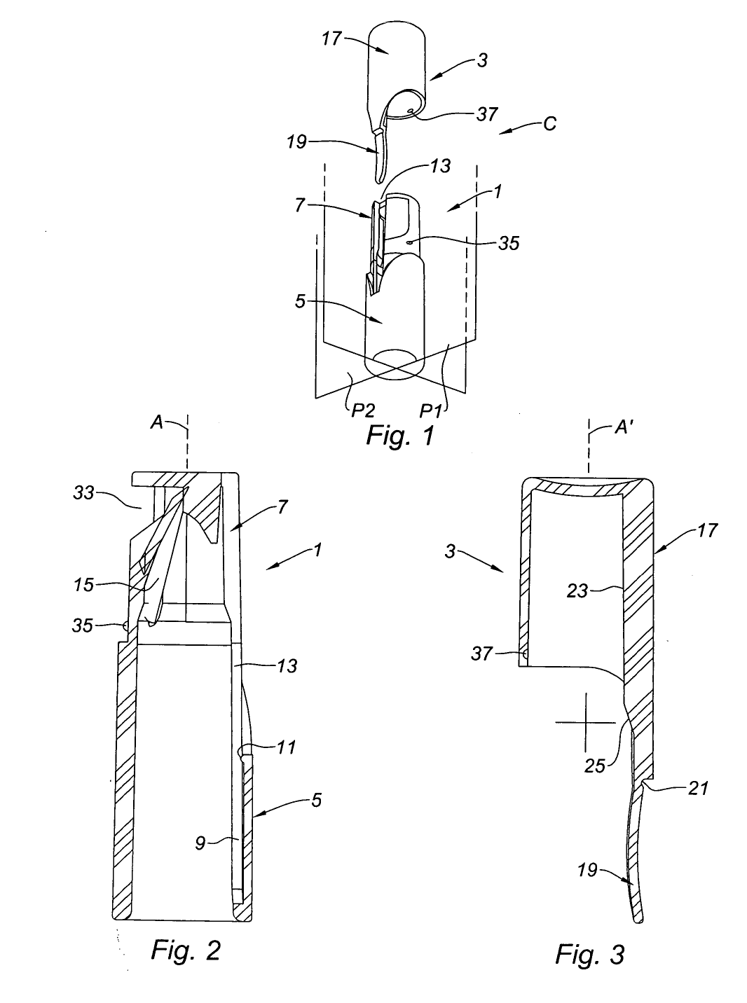

Refer now to FIGS. 1 and 3, in which it is seen that the cap of the invention comprises a cap body 1 and a cap top 3.

The cap body 1 has a substantially cylindrical hollow base 5 surmounted by a pencil-sharpener 7.

The base 5 has, on its inside face, a groove 9 with a lug 11 at the top followed by a longitudinal notch 13. The pencil-sharpener 7 includes a blade 15, preferably a metal blade, inclined to the axis A of the cap body 1. This is known in the art.

The base 5 and the pencil-sharpener 7 are preferably molded in one piece from a plastics material, for example.

The blade 15 may be either trapped in the plastics material or fixed by any appropriate means, such as a screw.

It will also be noted that the outside diameter of the pencil-sharpener 7 is preferably less than that of the base 5, as can be seen in FIG. 2 in particular.

Refer now to FIG. 3, in which it is seen that the cap top of the cap of the invention includes a substantially cylindrical capsule 17 and at least one clip 19 attached to the capsule.

As can be seen in FIG. 3, the clip 19 is curved toward the interior of the cap top 3, i.e. toward the axis A′ of the cap top.

In the region in which it is joined to the capsule 17, the clip 19 includes a depression 21.

The clip 19 has a molded-in rib 23 extending over the inside face of the capsule 17.

At its end 25 nearest the clip 19, the rib 23 is beveled so that its height is progressively reduced until it merges with the inside face of the capsule 17.

The angle of the bevel 25 relative to the axis A′ of the cap top 3 is preferably substantially equal to the angle of the blade 15 relative to the axis A of the cap body 1.

In an alternative variant that is not shown, the rib 23 and the bevel 25 may be on the inside face of the capsule 17 at a location other than that in line with the clip 19.

The cap body 1 and the cap top 3 are each preferably molded in one piece from a plastics material.

The plastics materials forming the cap body 1 and the cap top 3 may be identical (in terms of color, texture) or different.

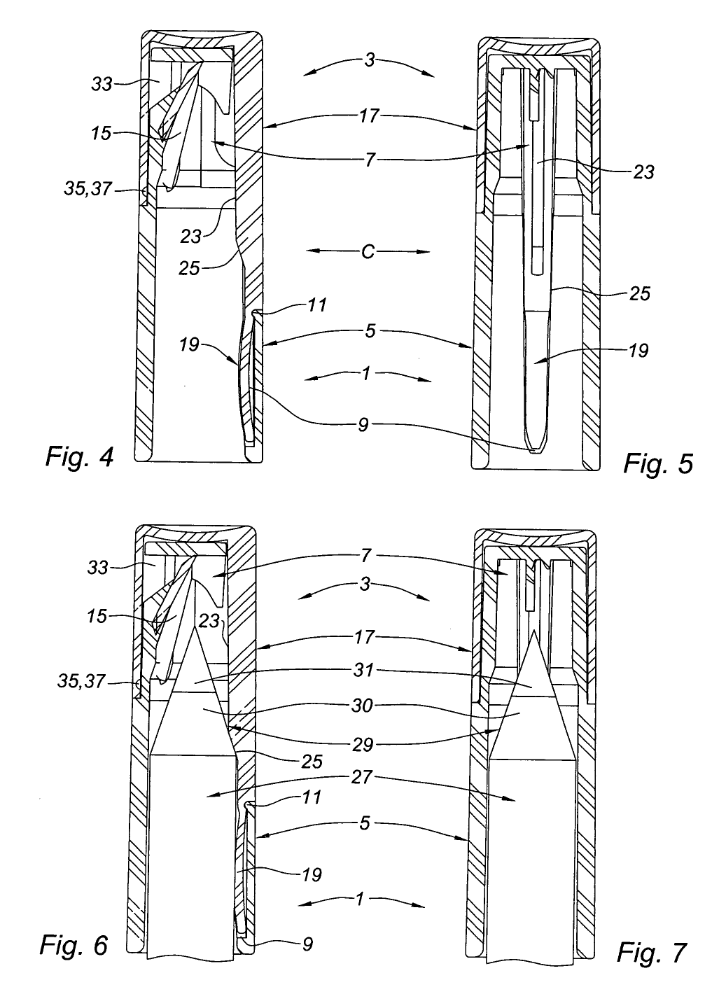

The plastics material forming the cap 3 is selected so that the clip 19 is springy, i.e. returns to its initial position shown in FIGS. 3 and 4 after it is urged away therefrom.

Plastics materials that may be suitable for the cap body 1 and the cap top 3 are the materials routinely known as POM and ABS, for example, or polycarbonate, or any other plastics material having the required properties.

In other variants, the cap body 1 and the cap top 3 of the cap of the invention could have any shape other than the cylindrical shape referred to above, such as an oval, rectangular or triangular section shape, for example.

Referring to FIGS. 4 and 5, the manner in which the cap body 1 cooperates with the cap top 3 when these two members are nested one inside the other can be seen.

The pencil-sharpener 7 is housed inside the capsule 17 of the cap top 3.

The clip 19 enters the cylindrical base 5 via the notch 13 and takes up a position inside the groove 9 so that its curvature protrudes relative to the inside face of the base 5.

The rib 23 and the beveled portion 25 of the rib also protrude relative to the inside face of the base 5.

It will also be noted that the depression 21 of the clip 19 cooperates with the lug 11 formed on the inside face of the base 5.

It will further be noted that the outside diameter of the capsule 17 is preferably made substantially equal to that of the base 5.

There can be seen in FIGS. 6 and 7 the way in which the cap of the invention, resulting from the nesting of the cap top 3 over the cap body 1, cooperates with the end of a pencil, in particular a cosmetic pencil 27, over which it is nested.

This end of the pencil includes a conical tip 29 produced by sharpening the pencil.

This conical tip itself comprises a wood or synthetic material portion 30, referred to hereinafter as the “chamfer”, and a lead 31.

As can be seen in FIG. 6, the beveled portion 25 of the rib 23 bears on the chamfer 30 of the tip 29 of the pencil 27.

The axial distance between the beveled portion 25 and the blade 15 is such that the tip 29, and above all the lead 31, of the pencil 27 remain separated from the blade by a predetermined distance.

It will also be noted that the curved portion of the clip 19 bears against the pencil 27.

The mode of use and the advantages of the cap of the invention follow directly from the preceding description.

When the pencil 27 is not in use, the cap C formed by the assembly of the cap top 3 and the cap body 1 is nested over the tip 29 of the pencil.

This cap therefore protects the tip 29, and in particular the lead 31, of the cosmetic pencil 27 when it is not being used.

When applying make-up, the pencil 27 is removed from its cap C.

A small traction force is sufficient to overcome the friction of the clip 19 against the pencil 27, this clip exerting a bearing force on the pencil 27 by virtue of its elasticity.

It will be noted that when the pencil 27 is extracted from its cap, the cap top 3 and the cap body 1 remain attached to each other because of the clipping effect resulting from the cooperation of the lug 11 on the cap body 5 with the depression 21 on the clip 19.

When the user has finished using the pencil 27, its tip 29 may again be covered by the cap, again by applying a slight force to overcome the friction of the clip 19.

It will be noted that the stroke of the pencil 27 inside the cap is limited by the beveled portion 25 of the rib 23, the chamfer 30 of the pencil abutting against this beveled portion.

This being the case, the tip 29 of the pencil 27, and above all the lead 31, remain a predetermined distance away from the blade 15 of the pencil-sharpener, thus preventing the blade cutting into the tip 29, and above all the lead 31, which could compromise the esthetics of the pencil and weaken the lead.

To sharpen the tip 29 of the pencil, the first step is to extract the pencil 27 from the cap C, as before.

Having done this, slight traction is applied to the cap body 1 and the cap top 3 to overcome the retaining force resulting from the cooperation of the lug 11 with the depression 21, and thereby separate the cap top 3 from the cap body 1.

The pencil 27 can then be inserted in the cap body 1 until its tip 29, and in particular its lead 31, come into contact with the blade 15.

The pencil 27 can then be rotated relative to the cap body 1 to sharpen the tip 29.

The shavings resulting from this sharpening leave the pencil-sharpener 7 through the orifice 33 provided for this purpose, in the manner known in the art.

Once sharpening of the pencil 27 has finished, it is removed from the cap body 1 and the cap top 3 replaced on the cap body 1.

If necessary, the tip of the clip 19 may be used to extract shavings that remain stuck inside the pencil-sharpener.

It will be noted that, when the pencil 27 is inside the cap C, as shown in FIGS. 6 and 7, it advantageously prevents movement of the clip 19 away from the inside face of the base 5, the effect of which is to prevent the lug 11 from escaping from the depression 21.

Accordingly, when the cap C is covering the end of the pencil 27, the cap top 3 is locked onto the cap body 1.

As is clear in the light of the foregoing description, the clip 19 restricts sliding of the pencil 27 inside the cap body 1 and the beveled portion 25 of the rib 23 forms an abutment preventing the tip 29, and above all the lead 31, from reaching the blade 15 of the pencil-sharpener 7.

This clip 19 and this beveled portion 25, which constitute means for restricting movement of the pencil 27 relative to the cap body 1, are attached to the cap top 17.

The consequence of this is that these restricting means are active only when the cap top 3 is nested over the cap body 1.

Accordingly, when, in particular, the cap top 3 is separated from the cap body 1 in order to sharpen the pencil 27, no friction force is exerted on the pencil 27 by the clip 19.

This enables the pencil 27 to be rotated relative to the pencil-sharpener 7 without excessive force and without rubbing liable to scratch the pencil, in contrast to the prior art situation.

It will further be noted that the elasticity of the clip 19 means that the cap body 1 may be fitted to pencils 27 having diameters varying slightly about a mean value.

These variations may result from dimensional tolerances inherent to the process of fabricating a given pencil, or from the use of the same cap on different pencils with similar diameters.

It will be noted that if the outside diameters of the base 5 and the capsule 17 are made substantially the same, the outside walls of the base and the capsule are aligned with each other, which imparts a particularly satisfactory esthetic appearance to the cap of the invention.

Of course, the present invention is in no way limited to the embodiment described and represented, which is provided by way of illustrative and nonlimiting example.

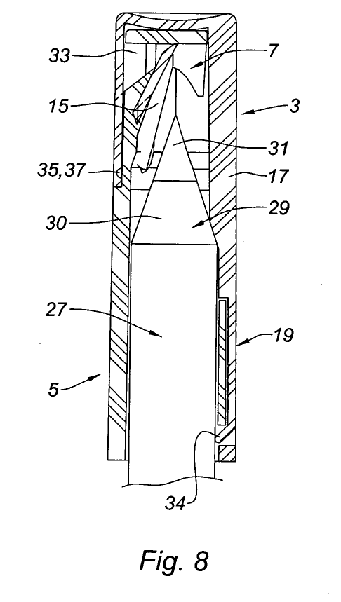

For example, a variant shown in FIG. 8 might be envisaged in which the clip 19 of the cap top 17 extends, rather than inside the cap body 1, on the outside thereof, in a groove reserved for this purpose, the clip then having at its end a lug 34 adapted to pass through the wall of the base 5 to apply a friction force to the pencil 27.

It should also be noted that there could be provided, in addition to or instead of the clipping means 11, 21, bosses 35 and recesses 37 (see FIGS. 1, 2, 3, 4 and 6) of complementary shape respectively inside the cap top 3 and on the cap body 1 (or vice-versa), for fastening the cap top and the cap body together, in particular during transportation and storage prior to fitting the cap to a pencil.

It will also be noted that a plurality of clips 19 bearing resiliently against the pencil 27 could be provided, distributed in any manner (i.e. regularly or irregularly) around the cap top 3.

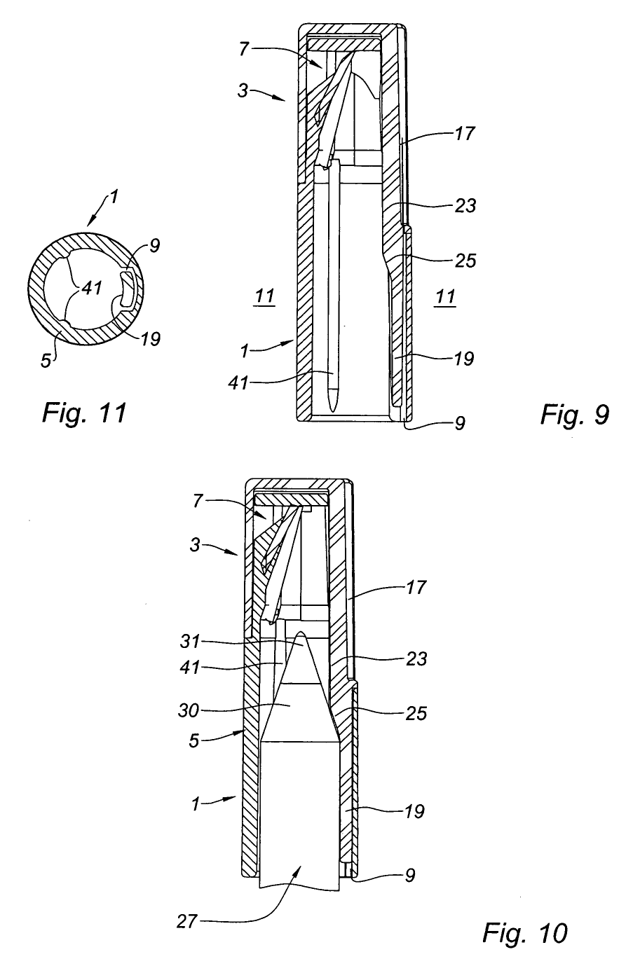

The variant shown in FIGS. 9 and 10 might also be envisaged, in which the rib 23 extends lower than in the preceding embodiments, whereby the tip, and above all the lead 31 of the pencil 27, is maintained lower inside the cap body 1.

Accordingly, if the cap body is fabricated from a transparent material, the lead 31 of the pencil 27 may be rendered visible from the outside, which is more convenient and agreeable for the user, the blade of the pencil-sharpener still being concealed by the opaque cap top.

It will also be noted that the clip 19 may be substantially straight, as shown in FIGS. 9 and 10, in which case it may be substantially more rigid than if it were curved (as is the case in the embodiments previously described).

It will also be noted that ribs 41 may be placed on the inside face of the cap body 1 to improve its retention on the pencil 27.

These ribs can be seen in FIGS. 9 and 11 in particular.

Two such ribs may be provided, for example, each disposed at approximately 120° relative to the rib 23.

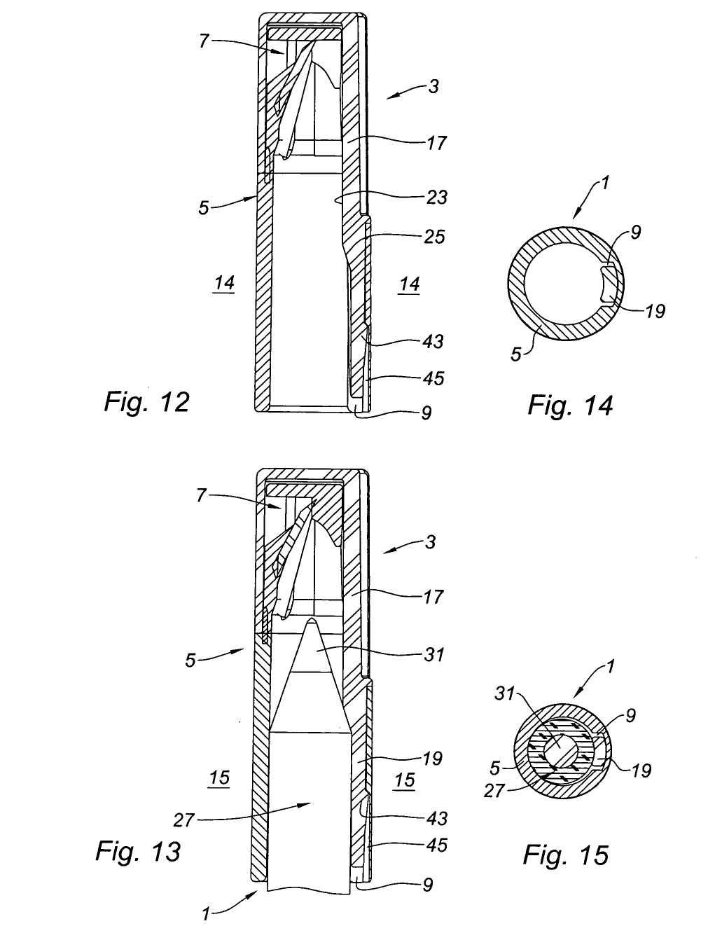

In the variant shown in FIGS. 12 to 15, the free end of the clip 19 incorporates a detent 43 cooperating with a shoulder 45 formed in the groove 9.

In this variant, as in that of FIGS. 2 to 7, it is necessary to extract the pencil 27 to be able to separate the cap top 3 from the cap body 1. If the cap top 3 is pulled with the pencil 27 still inside the cap body 1, the cap body 1 and the cap top 3 are pulled off together by virtue of the locking effect of the detent 43.

It will be noted that the groove 9 on the inside face of the cap body 1 is optional, and that the shoulder 45 could be formed directly in the inside wall of the cap body 1.

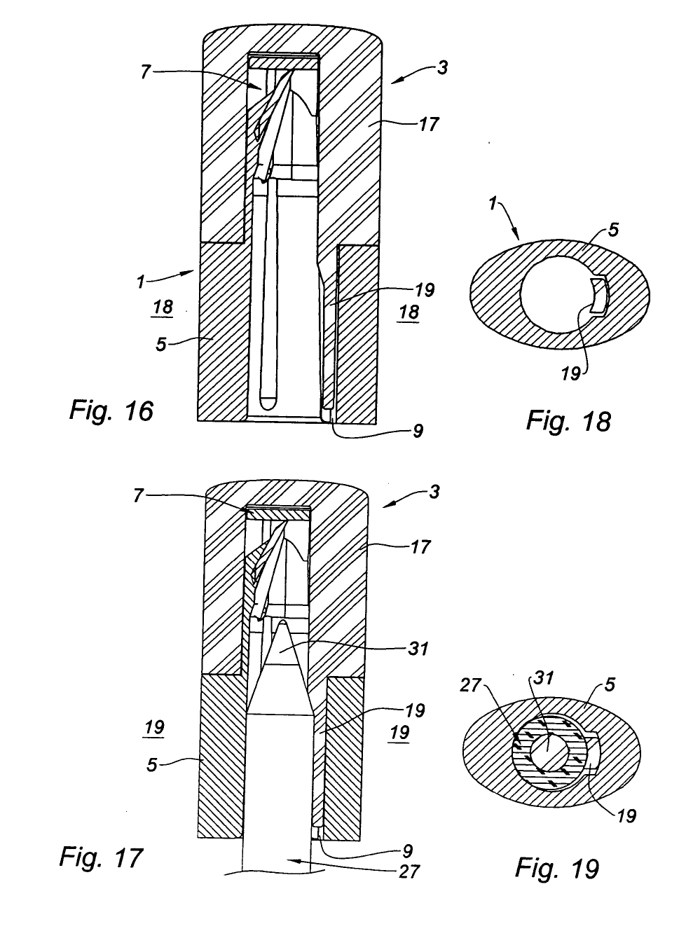

In the variant shown in FIGS. 16 to 19, the cap body 1 and the cap 3 have an oval section and the clip 19 locates in a groove 9 that is preferably formed in the thickest portion of the cap body 1.

It will of course be noted that the cap of the invention may be sold either on its own, in order to be fitted subsequently to one or more pencils, or with a pencil whose tip it already covers.

It will also be noted that the cap of the invention may be used for any type of pencil, whether a cosmetic pencil or otherwise.

1. A cap for a pencil, in particular a cosmetic pencil, comprising:
a cap body provided with a pencil-sharpener and adapted to be nested over one end of said pencil,
a cap top adapted to be nested fixedly onto said cap body, and
means attached to said cap top for restricting movement of said pencil relative to said cap body.

2. The cap claimed in claim 1 wherein said restricting means comprise means for maintaining a tip, and in particular a lead, of said pencil at a predetermined distance from a blade of said pencil-sharpener.

3. The cap claimed in claim 2 wherein said restricting means comprise a rib on the inside of said cap adapted to form an abutment for said pencil.

4. The cap claimed in claim 2 wherein said cap body is transparent and said abutment is positioned so that said lead can be seen through said cap body, said pencil-sharpener being concealed by said cap top, which may be opaque.

5. The cap claimed in claim 1 wherein said restricting means comprise at least one spring clip attached to said cap top and adapted to bear against said pencil.

6. The cap claimed in claim 5 wherein said clip is curved.

7. The cap claimed in claim 5 wherein said clip is straight.

8. The cap claimed in claim 4 wherein said cap body has a groove on its inside face and said clip is conformed to be housed in said groove when said cap top is nested over said cap body.

9. The cap claimed in claim 8 wherein said clip and said cap body comprise mutual clipping means releasable only when said clip is free to move away from said groove, i.e. when said pencil is extracted from said cap.

10. The cap claimed in claim 1 wherein said cap body and said cap top are shaped so that in the nesting configuration their outside walls are substantially in line with each other.

11. The cap claimed in claim 1 wherein the inside face of said cap body includes ribs to improve the retention of said cap body on said pencil.

12. A cosmetic pencil fitted with a cap as claimed in claim 1.

13. A cosmetic pencil fitted with a cap as claimed in claim 2.

14. A cosmetic pencil fitted with a cap as claimed in claim 3.

15. A cosmetic pencil fitted with a cap as claimed in claim 4.

16. A cosmetic pencil fitted with a cap as claimed in claim 5.

17. A cosmetic pencil fitted with a cap as claimed in claim 6.

18. A cosmetic pencil fitted with a cap as claimed in claim 7.

19. A cosmetic pencil fitted with a cap as claimed in claim 8.

20. A cosmetic pencil fitted with a cap as claimed in claim 9.

21. A cosmetic pencil fitted with a cap as claimed in claim 10.

22. A cosmetic pencil fitted with a cap as claimed in claim 11.
